(19) United States
(12) Patent Application Publication
(10) Pub. No.: US 2008/0284849 A1
(43) Pub. Date: Nov. 20, 2008

(54) Roofing site monitoring system

(76) Inventor: Gary Kassem, Sewickley, PA (US)

Correspondence Address: MEYER UNKOVIC & SCOTT LLP, 1300 OLIVER BUILDING, PITTSBURGH, PA, 15222, US

(21) Appl. No.: 12/220,429

(22) Filed: Jul. 23, 2008

Related U.S. Application Data
(62) Division of application No. 10/987,717, filed on Nov. 12, 2004, now abandoned.

(51) Int. Cl. H04N 7/18

(52) U.S. Cl. 348/143; 348/E07.085

(57) ABSTRACT

The present invention discloses a monitoring system for use at roofing project sites and, in particular, roof installation, repair and replacement sites. The monitoring systems include image-capturing devices, such as cameras that are positioned at a roofing project site and associated transmitters and a transmission system to send the project images to a remote and centralized project management location. The project images are received and processed for review at the project management location. In addition, the monitoring system can include a reciprocal communications system that permits a project manager, in the project management location, to send command signals to the image-capturing devices and adjust the position and focus of these devices. Further, the system may include a remote third party interface that permits a third party, such as a client/owner, design professionals including architects, engineers and other designers, material suppliers including manufacturers and distributors and inspectors/consultants, to remotely view the images transmitted from the project site and also control the position and focus of the image-capturing devices. Finally, the system may include a recording system to record the transmitted images from a particular site. In operation, the system may be replicated over multiple roofing project sites so that centralized and contemporaneous review of these sites from one location. The present invention also includes a method for simultaneous monitoring of multiple roofing site projects, with this method including the capturing, transmission and display of project site images at a centralized project management location. This method may also include centralized control and recording of the project site images, as well as an interfacing with third parties so that interested third parties can remotely view and control the project site images.

### BACKGROUND OF THE INVENTION

Roofing sites, including but not limited to roofing installations, removals, re-installation, and repairs, have a continuing need for project management and inspection. This need arises in part because roofing projects historically generate disputes and legal claims concerning issues of, among other items, alleged defective work or products. Often the various parties in the project, including the owner, contractors, design professionals, material suppliers and inspectors/consultants seek to shift responsibility for subsequent problems, such as leaks, to one another. Further, when roofers, roofing managers, or third party consultants or inspectors are involved in multiple projects, manpower may limit their ability to facilitate management inspection on a timely basis and may also increase over all project costs. While security systems at roofing sites have helped with some remote supervision, there remains a need for a monitoring system that allows for real-time communications with multiple roofing sites and project management through a centralized office. Additionally, a need exists to record a roofing project from beginning to end for use by both a number of parties, including the contractor, consultants and inspectors, materials suppliers including manufacturers and distributors, design professionals including engineers, architects and designers and the client/project owner.

In the roofing industry, the most qualified and experienced personnel typically assume management and supervisory responsibility such that they are physically located in an office, such as a corporate office, for a portion of their time, while having the need to supervise and manage multiple job sites. Qualified and experienced project managers and inspectors are in short supply, however, and on-site workers and installers are often inexperienced and often lack any formalized training. Historically, this has meant that roofing projects may be delayed until needed attention from supervisory or inspection personnel is obtained. Alternatively, substandard work may be provided where the assistance and management of qualified and experienced managers and inspectors is unavailable. Weather and travel needs may further impact the availability of project managers and supervisors at multiple job sites. Resulting delays impact the timing and cost of any given project. Thus, a need exists in the roofing industry to enable the most qualified and experienced supervisors and inspectors to monitor and supervise multiple job sites in an efficient manner and, more specifically, from a centralized location.

Additionally, on-site managers/supervisors are often fatigued from these same factors, i.e., travels and delays associated with multiple site supervision, which impact the quality of their work and supervision of the job site. Centralized project management would address this need area as well.

Related needs exist in connection with project documentation. From an owner's perspective, as well as from that of other parties having an interest in the project (contractors, design professionals and materials suppliers) one of the biggest expenses related to any roofing project is the hiring of a roofing consultant to monitor the progress and quality of the work on the project. Roofing projects can be one of the largest expenses of building or maintaining a structure. In addition, quality audits, as well as subsequent legal claims and proceedings can also be costly. As a result, owners and other interested parties, including warranty holders, can invest significant amounts of money in hiring consultants to monitor the progress and the quality of work of any roofing project. Full-time inspectors are extremely costly, however. Additionally, should something go wrong with a roofing project, owners and other interested third parties, with or without roofing consultants, can also spend significant money attempting to investigate the quality of the roofing work with uncertain results because of the lack of record evidence concerning the history of the project. Similarly, roofing companies, as well as design professionals and materials suppliers incur expenses in defending their work in litigation without a concrete means for establishing how their work was performed and the quality of their work. A need exists for an accurate manner to document any roofing project for future use.

### BRIEF SUMMARY OF THE INVENTION

One embodiment of the present invention provides for a monitoring system for use at roofing sites. The system includes the use of at least one image-capturing device at a job site that is connected to a transmitter. The transmitter transmits the images to a receiver. Preferably, this receiver is located in a centralized location and functions with other receivers to permit review and supervision of multiple job sites in a single location. The receiver interacts with a display device to display the project images in real time at the project management location.

Another embodiment of the present invention builds upon the above-identified embodiment by adding a reciprocal communications system that enables real time communications between the location of the image-capturing device and the location of the receiver.

A further embodiment of the present invention provides for the addition of a third party interface, that enables third parties, such as clients/owners, design professionals, material suppliers and inspectors/consultants to monitor the progress of the roofing project. This embodiment can build on either of the above-identified two embodiments of the present invention.

Finally, the present invention can include a recording system that records and documents the project images from start to finish for a particular roofing site project.

The present invention also includes a method for simultaneous monitoring of multiple roofing site projects, with this method including the capturing, transmission and display of project site images at a centralized project management location. This method may also include centralized control and recording of the project site images, as well as an interfacing with third parties so that interested third parties can remotely view and control the project site images.

The phrases “roofing project” and “roofing site project” are used throughout this text to include, but not be limited to, any roof installation, roof removal, re-installation, and roof repair work. It will be obvious to those skilled in the art that the present invention can be applied to a variety of similar construction applications with equal success, including but not limited to road pavement, parking lot surfacing and resurfacing sites. All such alternatives are disclosed by and included within the scope of this application.

The above summary of the present invention is not intended to describe each and every embodiment or every implementation of the present invention. The figures and detailed description that follow more particularly exemplify various embodiments of the present invention.

### DETAILED DESCRIPTION OF THE DRAWINGS

While the invention is amenable to various modifications and alternatives forms, specific embodiments have been shown by way of example only in the drawings and will be described in detail. It should be understood, however, that the intention is not to limit the invention to the particular embodiments described. On the contrary, the intention is to cover all modifications, equivalents, and alternatives following within the spirit and scope of the invention as defined by the appended claims.

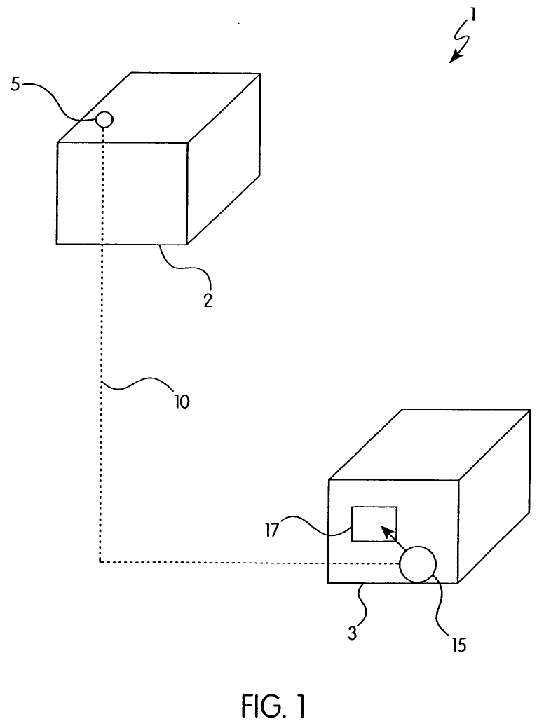

FIG. 1 is a schematic representation of one embodiment of the present invention;

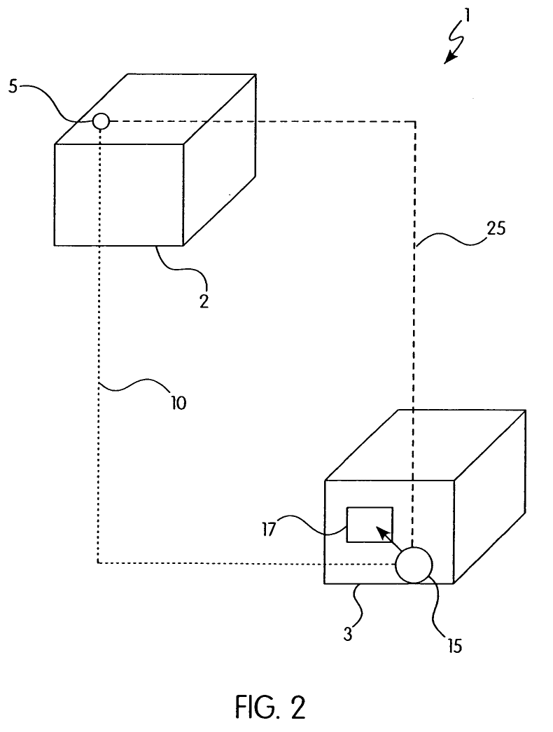

FIG. 2 illustrates another embodiment of the present invention having a reciprocal communications system;

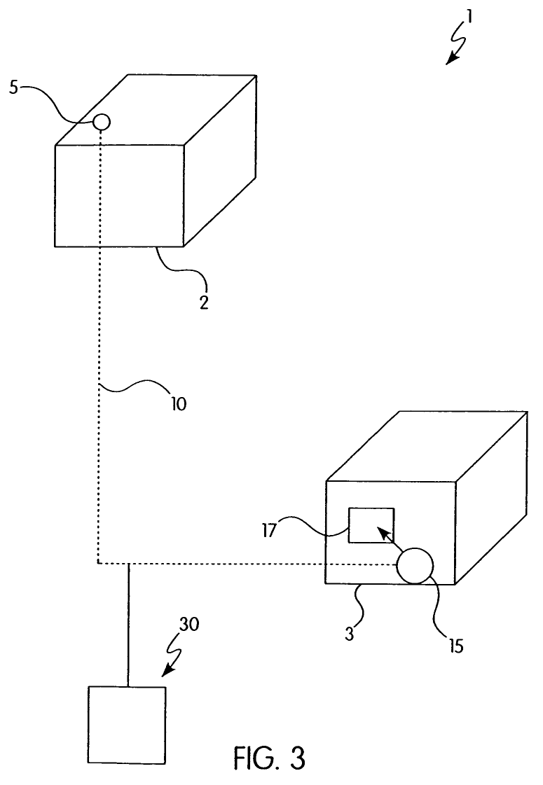

FIG. 3 illustrates another embodiment of the present invention having a remote third party interface; and

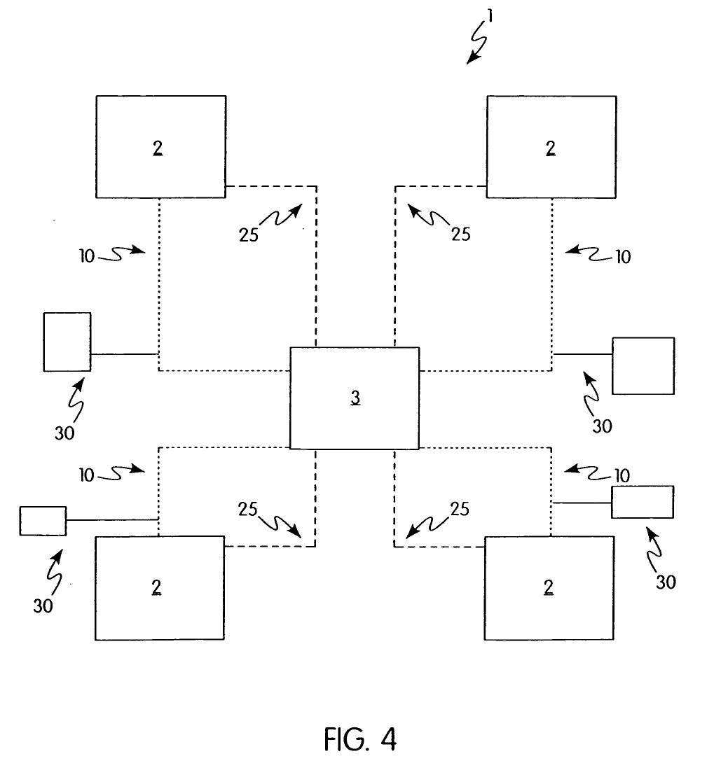

FIG. 4 illustrates an embodiment of the present invention having a central project management location tied into multiple roofing sites via the transmitters and having a third party interface for each roofing site.

### DETAILED DESCRIPTION OF THE INVENTION

Referring to FIGS. 1-4, one embodiment of the present invention relates to a monitoring system (1) for roofing projects. The monitoring system (1) allows any individual, including but not limited to a roofing manager, supervisor or inspector, to centrally manage several roofing site projects (2) from a single location, referred to herein as the project management location (3). A further embodiment of the present invention allows additional parties, including a client/owner, design professionals such as architects, engineers and other designers, material suppliers such as manufacturers and distributors, and third party consultants/inspectors, to monitor the roofing site project (2) from a remote location via a third party interface (30). Another embodiment of the present invention includes the recording of information collected from the roofing site (2). This provides the roofing contractor, project manager, inspector and/or the client/owner with a recorded history of the project from start to finish. In operation, the monitoring system of the present inventions permits interested parties to view and monitor multiple projects in a single location at the same time. The number of projects that can be monitored simultaneously is limitless. The following discussion of various embodiments of the present invention is intended to be an illustrative, but not exhaustive, list of possible embodiments. It will be obvious to one skilled in the art that other embodiments are possible and are included within the scope of this invention.

Referring to FIG. 1, in a preferred embodiment the roofing site monitoring system (1) of the present invention includes one or more image-capturing devices (5), such as still (digital or non-digital) or video cameras, that are pivotally mounted to cover one or more views of the roofing site project (2). The image-capturing devices (5) are each connected to a transmitter, which sends the image signals associated with the captured images, via a transmission system (10), to the project management location (3). Preferably, the image-capturing devices (5) transmit real-time video pictures of the roofing site project, although still photographs may also be transmitted. The pictures may be captured and transmitted in color or in black and white. The image-capturing devices can also be provided by other available technology, including a point and shoot digital and film cameras, camera phones or cellular cameras, digital and film camcorders and video cameras, 3D image capture cameras, webcams, and high resolution camera

Again referring to FIG. 1, the project site images are transmitted to the project management location (3), where simultaneous monitoring of several roofing or installation projects can occur. By way of example, but not limitation, such image transmission (10) can occur by any form of transmission technology, including but not limited to: wire or cables, including fiber optic cable; wireless transmission, including satellite link; microwave; cellular and Internet connection. Image transmission (10) can also occur through a combination of these technologies. For example, images can first be transmitted from the project site image-capturing devices (5) to a satellite system. From there, the image signals can be forwarded to a intermediary signal processing center that processes and forwards the signals to the project management location (3) by a final transmission network, such as fiber optic cable or an internet connection.

At the project management location (3), a receiver (15) receives and processes project site image signals for display on a display device (17) such as a monitor or projector. In one embodiment of the present invention, a room or amphitheater, with several display devices (17), can be designed at the project management location (3) to receive and coordinate all information received from and sent to the display devices (17). Preferably, a single office can be used to manage projects in a national or global marketplace, thus, significantly decreasing the number of on-site project managers, inspectors, consultants or other party representatives that are needed. The number of projects that can be simultaneously monitored is, in theory, limitless and is bounded only by the size of the office and the restraints of available technology. By way of example, but not limitation, the display devices may be selected from the group consisting of a monitor, a screen, a television, a computer display, a liquid-crystal display, a handheld or desktop computer, a camera or cellular phone and a projector or projection device. In the context of computers, a display is a computer output surface and projecting mechanism that shows text and often graphic images to the computer user, using a cathode ray tube (CRT), liquid crystal display (LCD), light-emitting diode, gas plasma, or other image projection technology. The display is usually considered to include the screen or projection surface and the device that produces the information on the screen. In some computers, the display is packaged in a separate unit called a monitor. In other computers, the display is integrated into a unit with the processor and other parts of the computer. (Some sources make the distinction that the monitor includes other signal-handling devices that feed and control the display or projection device. However, this distinction disappears when all these parts become integrated into a total unit, as in the case of notebook computers.) Displays (and monitors) are also sometimes called video display terminals (VDTs). The terms display and monitor are often used interchangeably. Most computer displays use analog signals as input to the display image creation mechanism. This requirement and the need to continually refresh the display image mean that the computer also needs a display or video adapter. The video adapter takes the digital data sent by application programs, stores it in video random access memory (video RAM), and converts it to analog data for the display scanning mechanism using an digital-to-analog converter (DAC).

Referring to FIG. 2, in a further embodiment of the present invention, the roofing site monitoring system (1) further includes a reciprocal communication system (25) whereby the project manager can send command signals back to the image-capturing devices (5) and control the position of the devices (5). Preferably, this control function and related communication system (25) uses the same transmission system (10) that transmits the image signals to the project management location (3). Alternatively, though, a separate communications system (25) may be established. Further, a back-up communication system (25) may also be implemented. In operation, the project manager sends control signals to the image-capturing devices (5) to control (i) focus, (ii) rotation of the device in a horizontal plane, and (iii) upward and downward pivoting of the device (5) in a vertical plane. In this embodiment, a control command transmitter is associated with the project management location and serves to generate the command signals that are transmitted to each project site by the control command transmissions system (25). Each image-capturing device (5) has a control command receiver and control mechanism to implement the command functions described above. The control command communications system (25) can be provided by any form of transmission technology, including but not limited to: wire or cables, including fiber optic cable; wireless transmission, including satellite link; and Internet connection. The control command communications system (25) can also be implemented through a combination of transmission technologies.

In operation, the project manager can view the roofing project in real time and control the focus and position of the cameras while monitoring the project. Referring to FIG. 4, the monitoring system (1) of the present invention allows a single project manager at project management location (3) to monitor and control several projects (2) at one time from a centralized remote location (3). Such centralized monitoring facilitates streamlining project management as well as providing costs savings.

Referring to FIG. 3, a further alternative embodiment of the present invention provides a remote third party interface system (30) that allows a third party, including a client/owner, design professionals such as architects, engineers or other designers, material supplier suppliers such as manufacturers or distributors, and third party inspectors and consultants, also to remotely view, in real time, the project images and, preferably, also to control the position and focus of the image-capturing devices (5). Preferably, the third party interfaces with the project management location (3) and the third party review of images and control commands are processed through the same transmission and communications systems (10) and (25) used by the project manager to coordinate with the roofing site project. The third party interface can occur by any form of transmission technology, including but not limited to one or a combination of the following: wire or cables, including fiber optic cable; wireless transmission, including satellite link; cellular; microwave and Internet connection. Preferably, the image-capturing devices (5) revert to a default setting within a fixed time after the third party last sends a control command.

Referring generally to FIGS. 1-3, the roofing site monitoring system (1) also preferably includes, in another embodiment, a recording system whereby all project site images are recorded at the project management location (3). Such recording allows both the project manager/supervisor/inspector and other interested third parties to have better over all documentation of the project. Such documentation has particular application and value in the context of issues and legal claims that might arise after project completion concerning alleged defects such as leaks. Specifically, the recordings can provide documentation and evidence of the project history in connection with future legal claims should they arise. Additionally, the recordings can be used as instructional and teaching aids. The recording system may use any suitable form of recording medium, such DVD, VHS tapes, CD Rom, computer tapes, digital data storage media, analog data storage media, film or other media.

As described above and depicted in FIG. 4, the present invention provides a monitoring system (1) for use at a number of different roofing site projects (2). The present invention also includes a method for simultaneous monitoring of multiple roofing site projects, with this method including the capturing, transmission and display of project site images at a centralized project management location. This method may also include centralized control and recording of the project site images, as well as an interfacing with third parties so that interested third parties can remotely view and control the project site images. The steps of the monitoring method of the present invention are implemented as described above.

The present invention should not be considered limited to the particular examples described above, but rather should be understood to cover all aspects to the invention as fairly set out in the attached claims. Various modifications, equivalents, and alternatives to which the present invention may be applicable will be really apparent to those of skill in the art to which the present invention is directed upon review of the present specification. The claims are intended to cover such modifications, equivalence, and alternatives.

1-14. (canceled)

15. A method for remote monitoring and documentation of one or more construction projects, comprising:
a. the installation of a remote monitoring system that transmits images of ongoing construction work in one or more parts of each said construction project for display at a centralized project management location; and;
b. the permanent recordation of such images for use in documenting construction work history and addressing construction defect, delay and warranty issues.

16. The method of claim 15, wherein said method further comprises the transmission of control commands from said centralized project management location to each said construction project to control the focus and position of said monitoring and transmission step.

17. The method of claim 15, wherein said method further comprises an interfacing between said centralized project management location and third parties so that said third parties can remotely monitor one or more of said construction projects.

18. The method of claim 16, wherein said method further comprises an interfacing between said centralized project management location and third parties so that said third parties can remotely monitor one or more of said construction projects and control the focus and position of said monitoring and transmission of said construction project, images.

19. (canceled)

20. The method of claim 15, wherein said construction project is a roofing installation project.

21. The method of claim 15, where said transmission between said construction project and said centralized project management location is comprised of a transmission and communication system selected from the group consisting of one or a combination of wire, cables, fiber optic cable; wireless transmission, satellite link; microwave, cellular and Internet connection.

22. The method of claim 17, where said remote third party interface is comprised of a transmission and communication system selected from the group consisting of one or a combination of wire, cables, fiber optic cable; wireless transmission, satellite link; microwave, cellular and Internet connection.

23. The method of claim 15, wherein said recording step uses a recording means selected of the group of recording media consisting of DVD, VHS tape, CD Rom, computer tapes, digital data storage media, analog data storage media and film.

24. A method for remote and centralized project management, inspection and consulting in connection with one or more roofing installation projects, comprising:
a. the installation of a remote monitoring system that transmits images of ongoing construction work in one or more parts of each said installation project for real-time display at a centralized location;
b. review of said real-time displays by a project manager at said centralized location and, based on said review, centralized project management of each said installation project by communication of project management directives from said centralized location to each said installation project; and
c. the permanent recordation of said images for use in documenting the construction work performed at each said installation project.

25. The method of claim 24, wherein said method further comprises the transmission of control commands from said centralized project management location to said remote monitoring system at each said installation project.

26. The method of claim 24, wherein said method further comprises an interfacing between said centralized project management location and third parties selected from the group consisting of clients, owners, design professionals, inspectors and consultants, so that said third parties can remotely monitor one or more of said installation projects.

27. The method of claim 26, wherein said method further comprises the transmission of control commands from said third parties to said remote monitoring system at each said installation project.

28. The method of claim 24, wherein said transmission between said construction project and said centralized project management location is comprised of a transmission and communication system selected from the group consisting of one or a combination of wire, cables, fiber optic cable; wireless transmission, satellite link; microwave, cellular and Internet connection.

28. The method of claim 26, wherein said remote third party interface is comprised of a transmission and communication system selected from the group consisting of one or a combination of wire, cables, fiber optic cable; wireless transmission, satellite link; microwave, cellular and Internet connection.

29. The method of claim 24, wherein said recording step uses a recording means selected of the group of recording media consisting of DVD, VHS tape, CD Rom, computer tapes, digital data storage media, analog data storage media and film.

30. The method of claim 24, wherein said method further comprises the use of said recorded images to resolve issues relating to construction delays, defects and warranties.

31. The method of claim 24, wherein said method further comprises the use of said recorded images as instructional and teaching aids.
